(19) United States
(12) Patent Application Publication
(10) Pub. No.: US 2026/0359652 A1
(43) Pub. Date: Nov. 12, 2026

(54) INDUSTRIAL INTERNET OF THINGS (IIOT) HETEROGENEOUS DATA PREDICTION METHOD AND APPARATUS BASED ON ATTENTION MECHANISM

(71) Applicant: Zhejiang University, Hangzhou City (CN)

(72) Inventors: Peng ZHAO, Hangzhou City (CN); Yifeng PAN, Hangzhou City (CN); Chengqian ZHANG, Hangzhou City (CN); Ruoxiang GAO, Hangzhou City (CN); Yiming CHEN, Hangzhou City (CN)

(21) Appl. No.: 19/671,315

(22) Filed: May 8, 2026

(30) Foreign Application Priority Data
May 8, 2025 (CN) 202510589938.X

(51) Int. Cl. G06N 3/09

(52) U.S. Cl. CPC G06N 3/09

(57) ABSTRACT

An Industrial Internet of Things (IIoT) heterogeneous data prediction method based on an attention mechanism can include: obtaining a historical dataset and constructing random imputation data based on random numbers; performing a data imputation operation on initial monitoring data based on the random imputation data, to obtain reconstructed monitoring data in a uniform dimension; forming a dataset by combining the initial monitoring data, the corresponding reconstructed monitoring data, and labels; training a neural network prediction model using the dataset, to obtain a monitoring data prediction model; and inputting current initial monitoring data into the monitoring data prediction model to obtain reconstructed monitoring data at a next time node. Further provided is an IIoT heterogeneous data prediction apparatus. The method provided in the present application can effectively couple the device operating status with process parameters in industrial scenarios, thereby achieving real-time assessment of the health status of processing devices.

### CROSS REFERENCE TO RELATED APPLICATION

This patent application claims the benefit and priority of Chinese Patent Application No. 202510589938.X, filed with the China National Intellectual Property Administration on May 8, 2025, the disclosure of which is incorporated by reference herein in its entirety as part of the present application.

### TECHNICAL FIELD

The present disclosure relates to the technical field of intelligent manufacturing, and in particular, to an Industrial Internet of Things (IIoT) heterogeneous data prediction method and apparatus based on an attention mechanism.

### BACKGROUND

In the field of IIoT, real-time monitoring and predictive analysis, as key technologies for improving production efficiency and ensuring device reliability, have practical application effects significantly constrained by the challenge of heterogeneous data processing. Due to significant differences in sensor configurations among different types of devices in industrial production environments, the acquired time-series data often exhibits multi-dimensional heterogeneous characteristics, specifically manifested as inconsistent data feature dimensions. Traditional data-driven methods typically require input data to have unified structural feature dimensions. This rigid constraint forces the system developers to face a dilemma: either constructing dedicated prediction models for specific device groups or using data imputation techniques to forcibly unify data dimensions. The former leads to exponentially increasing computational costs during large-scale deployment, while the latter relies on traditional methods such as linear interpolation and mean imputation, which often result in the loss of key feature information or increased noise interference when dealing with industrial time-series data with nonlinear dynamic correlations. More notably, the coupling relationship between the device operating status and process parameters in industrial scenarios exhibits time-varying characteristics, making static data alignment strategies ineffective at capturing such dynamic evolution patterns, and the resulting data distortion directly affects the generalization capability of prediction models. This underlying data processing defect not only reduces the real-time performance of device health status assessment, but may also lead to misjudgment of key process parameters, ultimately resulting in increased maintenance costs and reduced decision-making reliability.

Patent CN119415904A discloses an IIoT-based device fault warning method, apparatus and system, and a medium. The method includes: acquiring a plurality of types of operating data of a device; determining an initial attenuation factor for each type of operating data according to the volatility of each type of operating data; for any type of operating data, adjusting the initial attenuation factor based on a noise possibility of each piece of discrete data in the type of operating data, to obtain an adaptive attenuation factor for the type of operating data; using an exponentially weighted average algorithm for prediction based on the adaptive attenuation factor of each type of operating data, to obtain a plurality of predicted values for each type of operating data; and performing device fault warning based on the plurality of predicted values for each type of operating data.

Patent CN119363624A discloses an IIoT system anomaly detection method based on multivariate time-series data, including: S1, dividing raw multivariate time-series data into a raw training set and a raw test set; S2, normalizing the raw training set and the raw test set, and then performing time window segmentation to obtain a new training set and a new test set; S3, constructing a GTVformer model; S4, using the GTVformer model to train data in the new training set in two stages, so as to train two Transformer models in an adversarial manner to reconstruct normal input window data; and S5, using the trained GTVformer models to predict data in the new test set, to obtain a labeled result.

### SUMMARY

The objectives of the present disclosure are to provide an IIoT heterogeneous data prediction method and apparatus based on an attention mechanism. The method can effectively couple the device operating status with process parameters in industrial scenarios, thereby achieving real-time assessment of the health status of processing devices.

To achieve the first objective of the present disclosure, the following technical solution is provided: An IIoT heterogeneous data prediction method based on an attention mechanism includes following steps:
obtaining a historical dataset and constructing random imputation data based on random numbers, where the historical dataset includes initial monitoring data acquired by different types of sensors;
performing a data imputation operation on the initial monitoring data based on the random imputation data, to obtain reconstructed monitoring data in a uniform dimension;
labeling the initial monitoring data and the corresponding reconstructed monitoring data with labels based on time nodes, and forming a dataset by combining the initial monitoring data, the corresponding reconstructed monitoring data, and the labels;
training a pre-constructed neural network prediction model using the dataset, to obtain a monitoring data prediction model for predicting monitoring data at a next time node; and
inputting current initial monitoring data into the monitoring data prediction model to obtain reconstructed monitoring data at the next time node.

Specifically, the pre-constructed neural network prediction model includes a preprocessing module, a feature extraction module, and a prediction module;
the preprocessing module is configured to perform a data imputation operation on the input initial monitoring data to generate the corresponding reconstructed monitoring data, and input the reconstructed monitoring data into the feature extraction module;
the feature extraction module is configured to extract data features of the input reconstructed monitoring data and input extracted data features into the prediction module; and
the prediction module is configured to perform prediction based on the input data features, to output a prediction result.

Specifically, a specific process of the data imputation operation is as follows:
using the initial monitoring data as a query of the attention mechanism, using the constructed random imputation data as a key and a value of the attention mechanism, performing similarity calculation using the initial monitoring data and the random imputation data to obtain a corresponding similarity score, and performing attention weight calculation using the similarity score in combination with a mask activation function, to obtain a corresponding attention weight;
multiplying the attention weight with the random imputation data to output corresponding imputation data; and
performing a concatenation operation on the initial monitoring data and the corresponding imputation data to construct the corresponding reconstructed monitoring data.

Specifically, the attention mechanism includes additive attention, scaled dot-product attention, or general attention.

Specifically, the imputation data is masked using the mask activation function during calculation of the attention weight.

Specifically, an expression of the mask activation function is as follows:

$${softmax}_{mask} ( x [ : {l}_{val} ] ) = \frac{exp ( x [ : {l}_{val} ] )}{{\sum }_{t = 1}^{T} exp ( x [ : {l}_{val} ] )} ,$$

where
x[:lᵥₐᵣ] represents selecting first lᵥₐₗ items of x.

Specifically, the concatenation operation is implemented using a Concatenate function.

Specifically, during a training process, the pre-constructed neural network prediction model is trained using a mean absolute error and/or a mean squared error.

To achieve the second objective of the present disclosure, the following technical solution is provided: An IIoT heterogeneous data prediction apparatus is configured to execute the steps of the above IIoT heterogeneous data prediction method based on an attention mechanism.

Compared with the prior art, the present disclosure has the following beneficial effects:

The present disclosure can circumvent the limitations of traditional imputation strategies, generate new features through the attention mechanism, and append these generated features as imputation data to the raw data, thereby achieving real-time assessment of the device health status.

### BRIEF DESCRIPTION OF THE DRAWINGS

FIG. 1 is a flowchart of an IIoT heterogeneous data prediction method according to the embodiments; and

FIGS. 2A-2C are schematic diagrams of prediction results of different injection molding devices according to the embodiments.

### DETAILED DESCRIPTION OF THE EMBODIMENTS

In order to make the objectives, technical solutions and advantages of the embodiments of the present disclosure clearer, the following clearly and completely describes the technical solutions in the embodiments of the present disclosure with reference to accompanying drawings in the embodiments of the present disclosure. Apparently, the described embodiments are some rather than all of the embodiments. Generally, components of the embodiments of the present disclosure described and shown in the accompanying drawings may be arranged and designed in various manners. Therefore, the following detailed description of the embodiments of the present disclosure in the accompanying drawings is not intended to limit the protection scope of the present disclosure, but merely represent selected embodiments of the present disclosure. All other embodiments obtained by a person of ordinary skill in the art based on the embodiments of the present disclosure without creative efforts shall fall within the protection scope of the present disclosure.

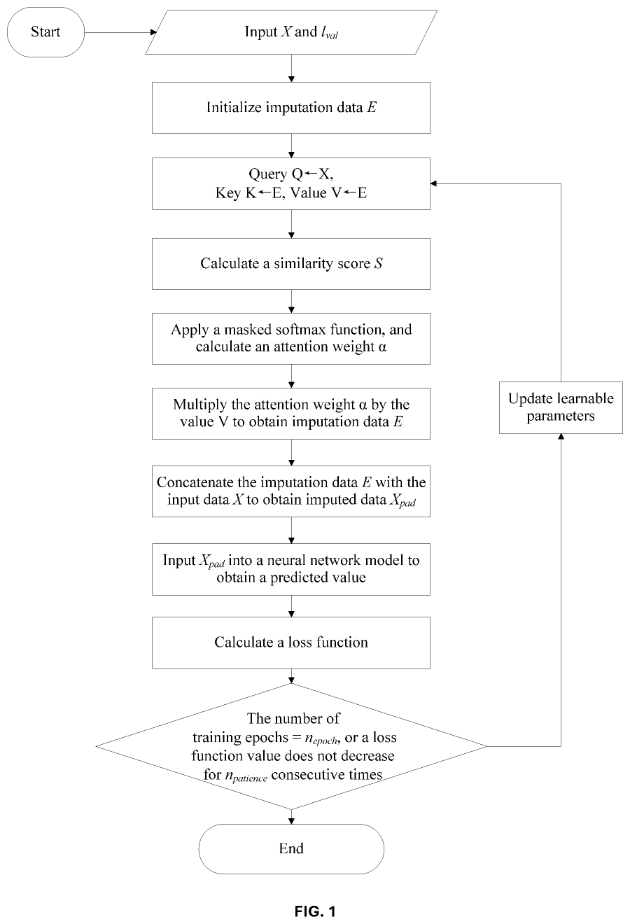

As shown in FIG. 1, the embodiments provide an IIoT heterogeneous data prediction method, and a specific process is as follows:

Given input data is raw data X, and the maximum number of features in the raw data is lₘₐₓ. Dimensions of the raw data are: the batch size n_{batch}, the historical data length Tₕᵢₛ, and the number lᵥₐₗ of data features.

First, random imputation data E is initialized, with the data dimension of 1, the historical data length Tₕᵢₛ, and the maximum number lₘₐₓ of data features.

The input raw data is used as a query of an attention mechanism, that is, Q←X; and the imputation data is used as a key and value of the attention mechanism, that is, K←E and V←E.

A similarity score S between the query and the key is calculated, and an attention weight is calculated. The calculation method herein may take different forms such as additive attention, scaled dot-product attention, or general attention, depending on the selected attention mechanism.

For the additive attention, a similarity function is calculated using Equation (1):

S_{add}(Q,K)=tanh(W_{q}Q+WₖK) (1)

S_{add} is a similarity score corresponding to the additive attention. W_{q} and Wₖ are learnable parameters.

A calculation method for an attention weight of the additive attention is shown in Equation (2):

$${α}_{add} = {softmax}_{mask} ( {W}_{v}^{T} S ( Q , K ) ) \qquad ( 2 )$$

α_{add} is the weight of the additive attention, and Wᵥ is a learnable parameter. softmax is an activation function commonly used in neural networks, and the softmaxₘₐₛₖ function is a masked softmax function, in which imputation data is masked, and a calculation method is shown in Equation (3):

$${softmax}_{mask} ( x [ : {l}_{val} ] ) = \frac{exp ( x [ : {l}_{val} ] )}{{\sum }_{t = 1}^{T} exp ( x [ : {l}_{val} ] )} \qquad ( 3 )$$

x[:lᵥₐₗ] represents selecting first lᵥₐₗ items of x.

A similarity function and a calculation method for an attention weight of the scaled dot-product attention are shown in Equations (4) and (5):

$${S}_{dot} ( Q , K ) = \frac{{QK}^{T}}{\sqrt{{d}_{k}}} \qquad ( 4 )$$

$${α}_{dot} = {softmax}_{mask} ( {S}_{dot} ( Q , K ) ) \qquad ( 5 )$$

S_{dot} (Q, K) is the similarity function of the scaled dot-product attention, dₖ is the dimension of the key sequence, and α_{dot} is the attention weight of the scaled dot-product attention.

A similarity function and a calculation method for an attention weight of the general attention are shown in Equations (6) and (7):

S_{gen}(Q,K)=QWᵣK (6)

α_{gen}=softmaxₘₐₛₖ(S_{gen}(Q,K)) (7)

S_{gen} (Q, K) is the similarity function of the general attention, Wᵣ is a trainable parameter, and α_{gen} is the attention weight of the general attention.

Multiplying the attention weight by the value yields the final imputation data, as shown in Equation (8):

P=αV (8)

P is the imputation data, and α is the calculated attention weight of the selected attention mechanism.

Concatenating the imputation data with the raw data yields the final imputed data, as shown in Equation (9):

X_{pad}=Concatenate(X[:,:,:lᵥₐᵣ],E[:,:,lᵥₐₗ:lₘₐₓ],−1) (9)

X_{pad} is the final imputed data, the Concatenate (a,b, −1) function represents a concatenation operation on a and b along the last dimension, and X[:,:,:lᵥₐᵣ] denotes selecting the first lᵥₐₗ values for the last dimension of X.

After completing the data imputation operation, the imputed data X_{pad} is input into a prediction model. This method employs an encoder-decoder long short-term memory (LSTM) neural network based on temporal attention. An encoder-decoder architecture includes an encoder and a decoder. The encoder encodes the input data into a fixed-dimensional context vector, and the decoder generates a final predicted value based on the context vector. In this method, the encoder is an LSTM neural network, and the decoder is an LSTM neural network based on temporal attention. In the encoder, the LSTM neural network performs computations for each time step, as shown in Equations (10), (11), and (12):

iₜ=σ(Wᵢ[hₜ₋₁,Xₜ]+bᵢ) (10)

fₜ=σ(W_{f}[hₜ₋₁,Xₜ]+b_{f}) (11)

oₜ=σ(Wₒ[hₜ₋₁,Xₜ]+bₒ) (12)
iₜ, fₜ, and oₜ are an input gate, a forget gate, and an output gate, respectively. t is a historical time step. Wᵢ, W_{f}, and Wₒ are trainable network weights. bᵢ, b_{f}, and bₒ are bias vectors. hₜ₋₁ is a hidden state. Xₜ is input data at a current historical time step. σ represents a sigmoid activation function, expressed as

$$σ ( x ) = \frac{1}{1 + {e}^{- x}} .$$

Update methods for a cell state and a hidden state of the LSTM neural network are shown in Equations (13) and (14):

cₜ=fₜ⊙cₜ₋₁+iₜ⊙ tanh(W_{c}[hₜ₋₁,Xₜ]+b_{c}) (13)

hₜ=oₜ⊙ tanh(cₜ) (14)

cₜ is the cell state, and hₜ is the hidden state. W_{c} and b_{c} are a learnable network weight and bias vector, respectively. ⊙ denotes element-wise multiplication. Dropout is used at the end of the encoder to prevent overfitting of network training. The final cell state

$${c}_{T}^{enc}$$

and the hidden state

$${h}_{T}^{enc}$$

are passed as context vectors to the decoder.

In the decoder, the cell state and hidden state of the LSTM network are first initialized based on the context vectors, as shown in Equations (15) and (16):

$${c}_{0}^{dec} = {c}_{T}^{enc} \qquad ( 15 )$$

$${h}_{0}^{dec} = {h}_{T}^{enc} \qquad ( 16 )$$

$${c}_{0}^{dec}$$

$$and$$

$${h}_{0}^{dec}$$

are an initial cell state and hidden state of the LSTM network in the decoder, respectively.

In the decoder, a temporal attention mechanism is first used to extract key features from the historical monitoring data. The final layer hidden state of the decoder from a previous time step is used as the query of the attention mechanism, that is, Q_{dec}←h^{dec} [−1]. The final layer hidden states of the encoder at all time steps are used as the key and value of the attention mechanism, that is, K_{dec}←h^{enc} and V_{dec}←h^{enc}. The additive attention, scaled dot-product attention, general attention, and the like may be used for temporal attention mechanism, with the calculation method as shown in Equations (1) to (7).

The historical data feature extracted by the temporal attention mechanism is shown in Equation (17):

Context=αV (17)

Context is the extracted historical data feature, and α is the attention weight calculated by the temporal attention mechanism.

The historical data feature is concatenated with the input of the decoding layer, as shown in Equation (18):

X_{dec,cat}=Concatenate(Context,X_{dec},−1) (18)

X_{dec,cat} is the concatenated decoder input, X_{dec} is the raw decoder input, and the Concatenate (a,b, −1) function represents a concatenation operation on a and b along the last dimension.

The calculation process of the LSTM network is shown in Equations (10) to (14). Finally, the final predicted value is obtained through a fully connected layer and the softmax activation function, as shown in Equation (19):

Ŷ=softmax(W_{y}Y_{dec}+b_{y}) (19)

Ŷ is the final predicted value, and Y_{dec} is the output value of the decoder. W_{y} and b_{y} are a learnable network weight and bias vector of the fully connected layer, respectively. The calculation method of the softmax function is

$$Softmax ( {x}_{i} ) = \frac{exp ( {x}_{i} )}{{\sum }_{j} exp ( {x}_{j} )} .$$

The loss function is calculated based on the predicted value. Forms of the loss function include a mean absolute error, a mean squared error, or the like. A masked loss function is adopted, and only the comparison among data of the raw length is considered when calculating the prediction accuracy. The calculation methods are shown in Equations (20) and (21):

$${L}_{mask , MAE} = \frac{1}{T \times {l}_{val}} {\sum }_{i = 1}^{T} {\sum }_{i = j}^{{l}_{val}} \vert \text{?} - {Y}_{i , j} \vert \qquad ( 20 )$$

$${L}_{mask , MAE} = \frac{1}{T \times {l}_{val}} {\sum }_{i = 1}^{T} {\sum }_{i = j}^{{l}_{val}} {( \text{?} - {Y}_{i , j} )}^{2} \qquad ( 21 )$$

L_{mask, MAE} and L_{mask, MSE} represent a masked mean absolute error loss function and a masked mean squared error loss function, respectively.

During the training process, learnable parameters are continuously updated. If the number of training epochs reaches the set value n_{epoch}, or if the number of consecutive training instances in which the loss function value does not decrease reaches the set value n_{patience}, training is stopped. The final obtained model can achieve accurate prediction of time series.

The embodiments further provide an IIoT heterogeneous data prediction apparatus, configured to execute the steps of the IIoT heterogeneous data prediction method provided in the above embodiments.

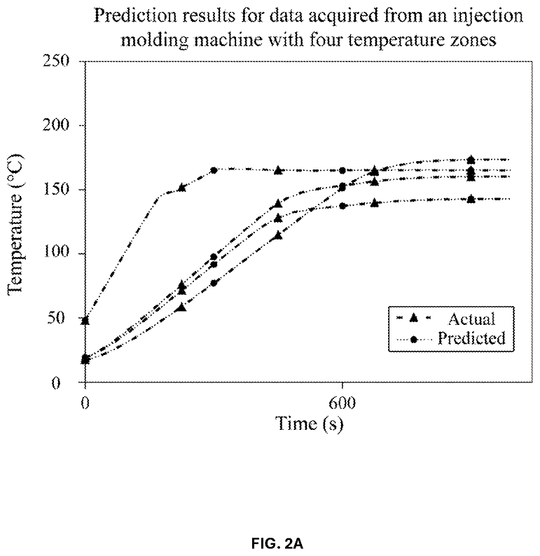

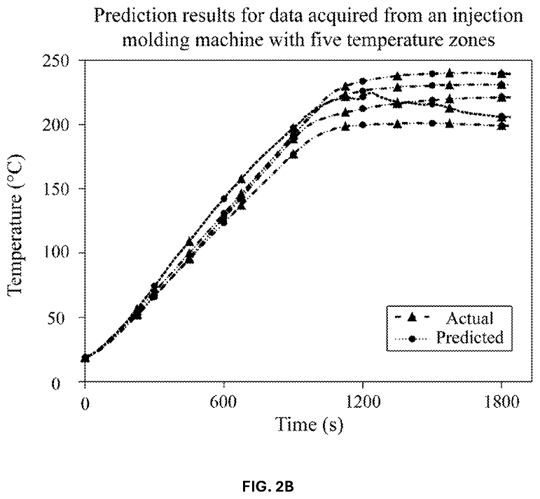

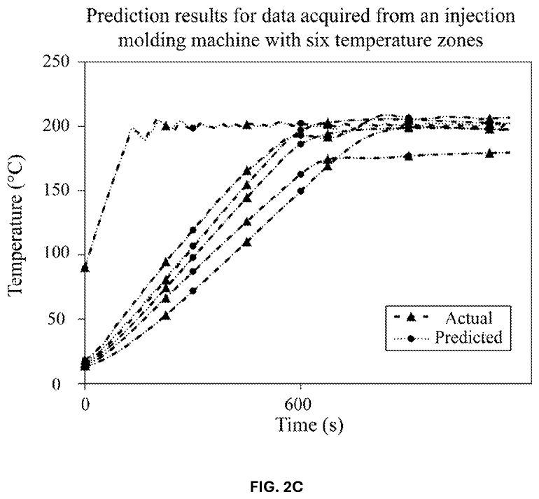

To better illustrate the technical effects of the method provided in the embodiments, verification was conducted in actual injection molding production under different dimensions. In the barrel heating process of injection molding, since different molding machines have different numbers of barrel temperature zones and accordingly different numbers of installed sensors, the dimensions of the acquired data vary. To address this issue, this method was applied and verified. Data was acquired from three different injection molding devices, namely, an injection molding machine with four temperature zones, a temperature control platform with five temperature zones, and an injection molding machine with six temperature zones, as shown in FIGS. 2A-2C.

Furthermore, the terms “upper”, “lower”, “inner”, “outer”, “front” and “rear” are used for descriptive purposes only and are not to be understood as indicating or implying relative importance. Unless otherwise specified, the relative arrangement, numerical expressions and numerical values of components and steps set forth in these embodiments do not limit the scope of the present disclosure.

The above-mentioned embodiments are only preferred embodiments of the present disclosure, and do not limit the implementation scope of the present disclosure. Therefore, all equivalent changes or modifications made according to the structure, features and principles described in the scope of the present disclosure shall be included in the protection scope of the present disclosure.

Finally, it should be noted that the above embodiments are merely specific implementations of the present disclosure, and are used to describe rather than limiting the technical solutions of the present disclosure. The protection scope of the present disclosure is not limited thereto. Although the present disclosure is described in detail with reference to the above examples, it should be understood that a person of ordinary skill in the art can still make modifications to or readily figure out changes in the technical solutions described in the above examples, or make equivalent substitutions on some technical features therein. These modifications, changes, or substitutions do not make the essence of the corresponding technical solutions depart from the spirit and scope of the technical solutions of the examples of the present disclosure, and shall all fall within the protection scope of the present disclosure. Therefore, the protection scope of the present disclosure shall be based on the protection scope of the claims.

What is claimed is:

1. An Industrial Internet of Things (IIoT) heterogeneous data prediction method based on an attention mechanism, comprising following steps:
obtaining a historical dataset and constructing random imputation data based on random numbers, wherein the historical dataset comprises initial monitoring data acquired by different types of sensors;
performing a data imputation operation on the initial monitoring data based on the random imputation data, to obtain reconstructed monitoring data in a uniform dimension;
labeling the initial monitoring data and the corresponding reconstructed monitoring data with labels based on time nodes, and forming a dataset by combining the initial monitoring data, the corresponding reconstructed monitoring data, and the labels;
training a pre-constructed neural network prediction model using the dataset, to obtain a monitoring data prediction model for predicting monitoring data at a next time node; and
inputting current initial monitoring data into the monitoring data prediction model to obtain reconstructed monitoring data at the next time node.

2. The IIoT heterogeneous data prediction method based on an attention mechanism according to claim 1, wherein the pre-constructed neural network prediction model comprises a preprocessing module, a feature extraction module, and a prediction module;
the preprocessing module is configured to perform a data imputation operation on the input initial monitoring data to generate the corresponding reconstructed monitoring data, and input the reconstructed monitoring data into the feature extraction module;
the feature extraction module is configured to extract data features of the input reconstructed monitoring data and input extracted data features into the prediction module; and
the prediction module is configured to perform prediction based on the input data features, to output a prediction result.

3. The IIoT heterogeneous data prediction method based on an attention mechanism according to claim 1, wherein a specific process of the data imputation operation is as follows:
using the initial monitoring data as a query of the attention mechanism, using the constructed random imputation data as a key and a value of the attention mechanism, performing similarity calculation using the initial monitoring data and the random imputation data to obtain a corresponding similarity score, and performing attention weight calculation using the similarity score in combination with a mask activation function, to obtain a corresponding attention weight;
multiplying the attention weight with the random imputation data to output corresponding imputation data; and
performing a concatenation operation on the initial monitoring data and the corresponding imputation data to construct the corresponding reconstructed monitoring data.

4. The IIoT heterogeneous data prediction method based on an attention mechanism according to claim 3, wherein the attention mechanism comprises additive attention, scaled dot-product attention, or general attention.

5. The IIoT heterogeneous data prediction method based on an attention mechanism according to claim 3, wherein the imputation data is masked using the mask activation function during calculation of the attention weight.

6. The IIoT heterogeneous data prediction method based on an attention mechanism according to claim 3, wherein an expression of the mask activation function is as follows:
$${softmax}_{mask} ( x [ : {l}_{val} ] ) = \frac{exp ( x [ : {l}_{val} ] )}{{\sum }_{t = 1}^{T} exp ( x [ : {l}_{val} ] )} ,$$
wherein
x[:lᵥₐₗ] represents selecting first lᵥₐₗ items of x.

7. The IIoT heterogeneous data prediction method based on an attention mechanism according to claim 3, wherein the concatenation operation is implemented using a Concatenate function.

8. The IIoT heterogeneous data prediction method based on an attention mechanism according to claim 1, wherein during a training process, the pre-constructed neural network prediction model is trained using at least one of a mean absolute error and a mean squared error.

9. An Industrial Internet of Things (IIoT) heterogeneous data prediction apparatus, configured to execute steps of the IIoT heterogeneous data prediction method based on an attention mechanism according to claim 1.

10. The IIoT heterogeneous data prediction method based on an attention mechanism according to claim 2, wherein a specific process of the data imputation operation is as follows:
using the initial monitoring data as a query of the attention mechanism, using the constructed random imputation data as a key and a value of the attention mechanism, performing similarity calculation using the initial monitoring data and the random imputation data to obtain a corresponding similarity score, and performing attention weight calculation using the similarity score in combination with a mask activation function, to obtain a corresponding attention weight;
multiplying the attention weight with the random imputation data to output corresponding imputation data; and
performing a concatenation operation on the initial monitoring data and the corresponding imputation data to construct the corresponding reconstructed monitoring data.

11. The Industrial Internet of Things (IIoT) heterogeneous data prediction apparatus according to claim 9, wherein the pre-constructed neural network prediction model comprises a preprocessing module, a feature extraction module, and a prediction module;
the preprocessing module is configured to perform a data imputation operation on the input initial monitoring data to generate the corresponding reconstructed monitoring data, and input the reconstructed monitoring data into the feature extraction module;
the feature extraction module is configured to extract data features of the input reconstructed monitoring data and input extracted data features into the prediction module; and
the prediction module is configured to perform prediction based on the input data features, to output a prediction result.

12. The Industrial Internet of Things (IIoT) heterogeneous data prediction apparatus according to claim 9, wherein a specific process of the data imputation operation is as follows:
using the initial monitoring data as a query of the attention mechanism, using the constructed random imputation data as a key and a value of the attention mechanism, performing similarity calculation using the initial monitoring data and the random imputation data to obtain a corresponding similarity score, and performing attention weight calculation using the similarity score in combination with a mask activation function, to obtain a corresponding attention weight;
multiplying the attention weight with the random imputation data to output corresponding imputation data; and
performing a concatenation operation on the initial monitoring data and the corresponding imputation data to construct the corresponding reconstructed monitoring data.

13. The Industrial Internet of Things (IIoT) heterogeneous data prediction apparatus according to claim 12, wherein the attention mechanism comprises additive attention, scaled dot-product attention, or general attention.

14. The Industrial Internet of Things (IIoT) heterogeneous data prediction apparatus according to claim 12, wherein the imputation data is masked using the mask activation function during calculation of the attention weight.

15. The Industrial Internet of Things (IIoT) heterogeneous data prediction apparatus according to claim 12, wherein an expression of the mask activation function is as follows:
$${softmax}_{mask} ( x [ : {l}_{val} ] ) = \frac{exp ( x [ : {l}_{val} ] )}{{\sum }_{t = 1}^{T} exp ( x [ : {l}_{val} ] )} ,$$
wherein
x[:lᵥₐᵣ] represents selecting first lᵥₐₗ items of x.

16. The Industrial Internet of Things (IIoT) heterogeneous data prediction apparatus according to claim 12, wherein the concatenation operation is implemented using a Concatenate function.

17. The Industrial Internet of Things (IIoT) heterogeneous data prediction apparatus according to claim 9, wherein during a training process, the pre-constructed neural network prediction model is trained using at least one of a mean absolute error and a mean squared error.
